(19) United States
(12) Patent Application Publication
(10) Pub. No.: US 2021/0312775 A1
(43) Pub. Date: Oct. 7, 2021

(54) BAIT PACK WITH GPS AND PROXIMITY ACTIVATION

(71) Applicant: William J. Marinelli, SR., WIlkesBarre, PA (US)

(72) Inventor: William J. Marinelli, SR., WIlkesBarre, PA (US)

(21) Appl. No.: 13/158,447

(22) Filed: Jun. 12, 2011

(51) Int. Cl. G08B 13/24; G07G 3/00

(52) U.S. Cl. CPC G08B 13/2462; G07G 3/003; G08B 13/248; G08B 13/2471

(57) ABSTRACT

A currency bait pack for tracking stolen currency bundles is activated by movement of the bait pack from a magnetic mounting in a teller drawer to transmit location information using GPS. The bait pack can include a power switch to isolate the battery power source from the GPS tracking device, or can include rechargeable batteries, or both.

### BACKGROUND OF THE INVENTION

This invention relates to a bait pack for locating stolen currency, and a method for using the same.

In the event a bank or other establishment is robbed, the standard protocol for safety of the employees is to place currency bricks (wrapped paper currency) in the robber's bag to avoid violence on the thief's part. Often, the employee will add an explosive dye pack, and/or, as a more recent development, a fake brick having a GPS (global positioning system) transmitter so that the currency can be tracked.

A problem with GPS-based bait pack (a fake brick) is that the battery powering the GPS must remain charged for extended periods. Further, a bait pack should be present in each teller's drawer, and so the batteries for multiple bait packs must be charged.

### SUMMARY OF THE INVENTION

This invention overcomes various deficiencies in existing bait packs by providing a GPS-based bait pack having a switch energizing the GPS unit only when the bait pack is removed from a predefined location. The device can include a system for conserving battery power, or can be rechargeable. This invention also provides a charger for the bait pack, as well as a charger for simultaneously charging the batteries of multiple bait packs.

This invention provides a bait pack for tracking stolen currency, comprising, a laminated hollow frame simulating a stack of currency, a cover for sealing the one opening of the hollow and comprising actual or simulated currency, a base for sealing the other opening of the hollow, and disposed within the frame a power source, a sensor including a switch activated by movement of the bait pack from a particular physical location, and a power switch, switched by sensor activation, connecting the power source to a GPS tracking device transmitting information on the location of the bait pack upon activation of the sensor.

This invention also provides a bait pack for tracking stolen currency, comprising a laminated hollow frame simulating a stack of currency, a board disposed in the hollow having attached thereto, a rechargeable battery having an electrical connection to a radio transmitter, a normally closed switch in series with the electrical connection and being magnetically activated to interrupt the electrical connection, a cover for sealing the one opening of the hollow and comprising actual or simulated currency, and an electrically insulating base for sealing the other opening of the hollow and having openings with contacts electrically connected to the battery disposed in the openings.

### BRIEF DESCRIPTION OF THE DRAWINGS

FIG. 1 is a top plan photographic view of the bait pack.

FIGS. 2A and 2B are, respectively, top plan and side schematic views of the bait pack.

FIG. 3 is a top plan photographic view of the charger.

FIG. 4 is a block diagram of an embodiment of the electronics.

FIG. 5 is a perspective view of a teller drawer with a magnetic base.

### DETAILED DESCRIPTION

A brick of uncirculated (“paper”) currency is about ⅜″ (˜0.95 cm) in height when laid upon a surface, and a brick of circulated currency is about 1″ (2.5 cm) in height at its highest point, about ¾″ (˜1.9 cm) at the wrapping strap, and both weigh about 3.5 oz. (˜100 g). The bait pack of this invention is preferably about ¾″ in height and about 4.5 oz (˜128 g) in weight. It is a realistic facsimile of a brick of 100 $1 bills (or other denomination or total dollar amount as may be desired), and can use one or more facsimile bills and/or one or more real bills of genuine currency for the simulation.

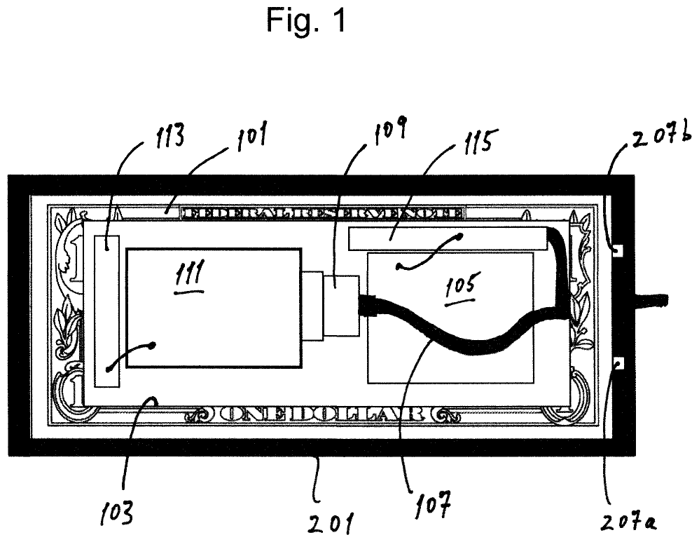

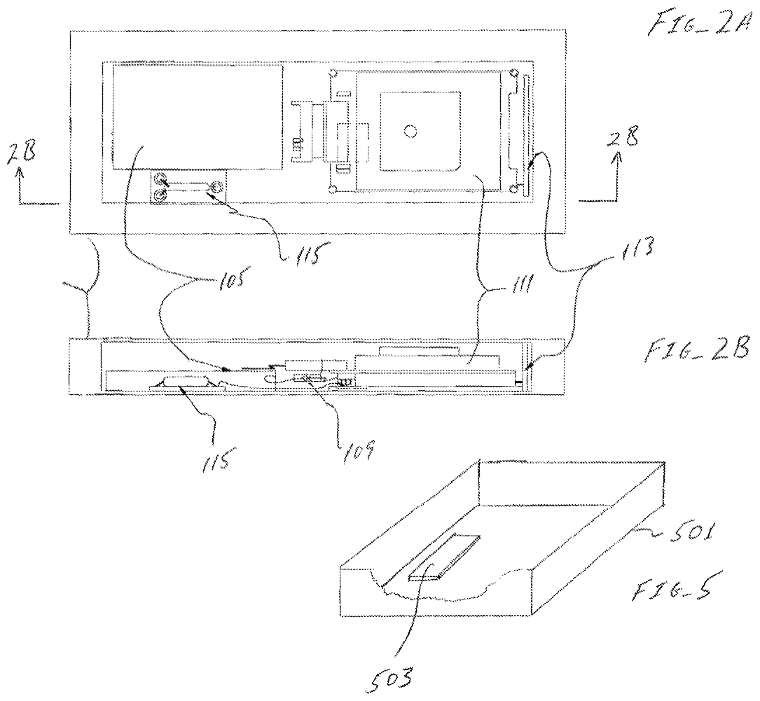

Referring to FIGS. 1, 2A, and 2B, the frame 101 of the bait pack is made of about 100 (preferably 125) individually cut sheets of facsimile currency each having a central opening 103 so that when sandwiched and secured together (mechanically and or adhesively) make a hollowed-out brick. An electronic circuit board is secured within the opening. A hard, thin sheet (such a mica) is adhered to the underside of a bill to form the cover that seals the top opening. The underside is sealed with an electrically insulating sheet (such as vulcanized rubber) having a number of openings in which contacts for charging the battery and other electrical connections if desired. The entire assembly is adhered together, preferably with an electrical epoxy binding tape that, over time, permanently bonds the laminate together. The board includes a battery 105, connected by a cable 107 and a connector 109 to a GPS transmitter 111 having an antenna 113. The electrical connection between the battery and the GPS unit passes through a normally closed magnetic switch 115. The battery can be rechargeable or non-rechargeable, and either may be replaceable or one-time use.

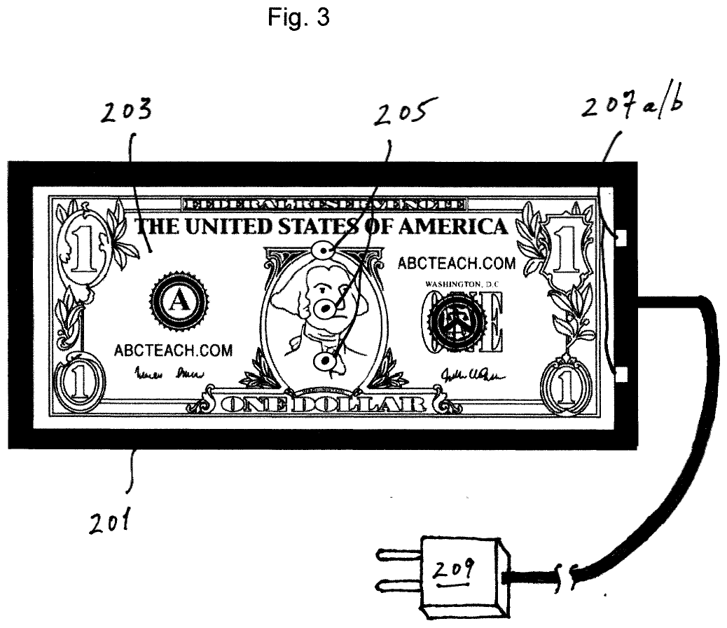

The pack shown in FIG. 1 is disposed in a charger 201 or charging cradle. FIG. 3 depicts the charger without the bait pack. The charger base has a registration bill disposed flat on the mating surface 203 for the underside of the bait pack to indicate the proper orientation of the bait pack for charging. A plurality of base electrical contacts 205 are provided for physical contact mating with corresponding contacts in the bottom insulating sheet of the bait pack. When the charger is energized, such as by using a standard charging adaptor 209 (e.g., 100-240 VAC at 50-60 Hz input, 6 VDC, 830 mA output, electrical plug, and electrical connection to the charger), the mating contacts charge the battery. Preferably, the charger includes indicator lights, such as a light 207a for indicating that the charger is energized, and another indicator light 207b for indicating that the battery is charging. The indicator lights are preferably LEDs. The charger can include a magnet to keep the switch open to avoid energizing the GPS during charging. At the close of business, the bait packs from the various teller drawers can be removed and placed in chargers. A mulitpack charger with angled bases (e.g., a series of bases angled at 45° is used to charge multiple bait packs simultaneously.

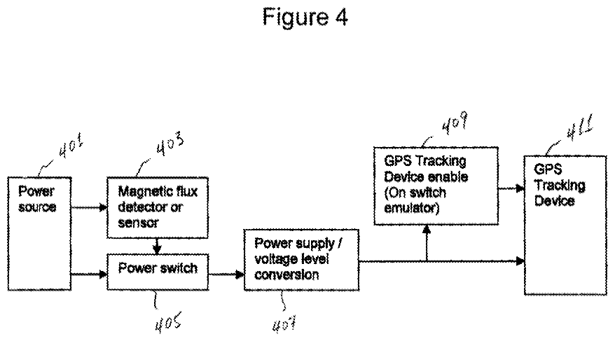

A system for conserving the battery power is shown in FIG. 4. The power source 401 (battery; e.g., one or more lithium batteries) is connected to both a magnetic flux detector or sensor circuit 403 and to a power switch 405, which are also connected together. The sensor circuit can include a reed switch activated magnetically, and the associated circuit should accommodate switch bounce and other noise in the sensor circuit to avoid false operation. When the sensor is activated, it switches the power switch, thereby powering the downstream portion of the system. The power switch separates the power source from the downstream portion (and the power switch), avoiding leakage and thereby preserving battery power. When the system operation is true, the power source characteristics can be converted in circuit 407, if required for downstream system components. The true operation transmits power to the GPS Tracking Device enable 409, which essentially simulates activation of the “on” switch for the GPS Tracking Device 411, and to the GPS Tracking Device itself. The latter (device 411) should be considered to include, although not shown separately, a GPS receiver, a transmitter relaying the GPS information received, an antenna, and any associated electronics for operation of the device to enable tracking of the bait pack. This system prolongs the battery life and can avoid the need for a bait pack that requires charging. Alternatively, the batteries can be rechargeable and, using this system, recharged only a few times per year.

Where the sensor circuit 403 includes a magnetic switch, it requires magnetic activation to engage the system and provide true operation. A drawer, such as a teller's drawer 501, is shown in FIG. 5 with a magnetic mounting 503 disposed in the base of the drawer. The bait pack lies in wait on the magnetic base, whereby the switch is poised and the battery in the bait pack is conserved. To assist in maintaining the bait pack on the mounting, mechanically engageable and releasable fasteners (such as Velcro brand) can be used, or the mounting surface can be made of a rubber material that will provide sufficient friction with the rubber base of the bait pack to increase the friction between the two. The bait pack should not slip off from the mounting as the teller drawer is opened and closed during normal use. The use of electronics with the attributes of the system shown in FIG. 4 conserves battery life and avoids the additional cost to the user of a charger, so the bait pack remains in the drawer and will always be present in the case of a robbery.

In the event of a robbery, while removing currency bricks from the drawer and filling the robber's bag, the teller takes the bait pack as if it were valid currency along with the other bricks. Removing the bait pack from the base activates the switch and thereby the GPS Tracking Device is activated. Computer software associated with a receiver for the transmitter in the GPS Tracking Device can determine the location of any particular bait pack once activated. The software can be programmed to send out an alarm signal to the police if the bait pack is removed a certain distance from the bank, and to avoid an alarm signal when the bait pack is removed for charging if the bait pack is rechargeable. In cash drawers having multiple compartments, a compartment may be reserved for a bait pack, or a cash drawer may include two bait packs.

While the invention has been described particularly with respect to banks, it should be appreciated that it can be used with any cash drawer. A department store or supermarket typically would use multiple drawers with multiple compartments as banks typically do and so would use multiple bait packs (one for the drawer in each cash register), while a convenience store or corner market may only have a single register with a single drawer (and maybe with a single compartment) and thus would need only a single bait pack. Further, the device is not limited to paper money, but is applicable to any token or device representing money so long as the GPS tracking signal can be sent out from the device. For example, a stack of casino chips (which can be non-metallic and thus not RF-shielding) can substituted for the stack of bills in the exemplar described above to make a bait pack, and could use a minimal number of chips to store the battery and transmitter. Alternatively, such a bait pack could be a bottom chip connected to a charging device with leads imbedded in the felt of the gambling table (and clearly not used for gambling, but able to be removed from the felt and so appearing to be a bona fide chip). Thus, as used in the claims, “currency” is intended to include gambling chips and other representations or tokens for actual currency.

The foregoing description is meant to be illustrative and not limiting. For example, the present system can be incorporated into a valuable or vehicle. Various changes, modifications, and additions may become apparent to the skilled artisan upon a perusal of this specification, and such are meant to be within the scope and spirit of the invention as defined by the claims.

What is claimed is:

1. A bait pack for tracking stolen currency, comprising:
a. a laminated hollow frame simulating a stack of currency;
b. a cover for sealing the one opening of the hollow and comprising actual or simulated currency;
c. a base for sealing the other opening of the hollow; and
d. disposed within the frame,
i. a power source;
ii. a sensor including a switch activated by movement of the bait pack from a particular physical location;
iii. a power switch, switched by sensor activation, connecting the power source to
iv. a GPS tracking device transmitting information on the location of the bait pack.

2. The bait pack of claim 1, wherein the sensor is activated by magnetic flux.

3. The bait pack of claim 1, further comprising a power converter connected between the power switch and the GPS tracking device.

4. The bait pack of claim 1, further comprising an emulator simulating an “on” activation signal to the GPS tracking device and connected between the power switch and the GPS tracking device.

5. The bait pack of claim 3, further comprising an emulator simulating an “on” activation signal to the GPS tracking device and connected between the power converter and the GPS tracking device.

6. The bait pack of claim 2, in combination with and further comprising a drawer, the drawer having a particular physical location including mounting disposed in the base of the drawer, the mounting have a magnet effective for activating the sensor when the bait pack is moved from the mounting.

7. The bait pack of claim 1, in combination with a charger comprising a mating surface indicating the proper orientation of the bait pack when charging, and having electrical contacts arranged to physically engage said contacts in the insulating base when in contact therewith, and a charging adapter.

8. A method for tracking stolen currency, comprising:
a. providing a bait pack simulating a currency brick, a power source therewithin having an electrical connection to a GPS tracking device, and a sensor therewithin that is magnetically activated to indicate that the bait pack is being stolen, the power source being electrically separated from the GPS tracking device until the sensor is activated;
b. providing a teller drawer having a mounting in the base thereof comprising a magnet effective for activating said sensor when the bait pack is removed from the mounting; and
c. receiving a radio signal from the GPS Tracking device while the bait pack is removed from the mounting and the sensor activated.

9. The method of claim 8, further comprising converting the power from the power source received by the GPS tracking device.

10. A method for tracking stolen currency, comprising:
a. providing a bait pack simulating a currency brick and having a rechargeable battery with an electrical connection to a radio transmitter and a switch that is magnetically activated to a normally open position interrupting said electrical connection;
b. providing a teller drawer having a mounting in the base thereof comprising a magnet effective for activating said switch to said normally open position when the bait pack is in contact with the mounting; and
c. receiving a radio signal from the transmitter when the bait pack is removed from the mounting and the switch closes.

11. The method of claim 10, wherein the transmitter is a GPS unit and the signal is indicative of a location.

12. The bait pack of claim 1, further comprising a mounting having a magnet effective for activating the sensor when the bait pack is moved from the mounting.
